(19) United States
(12) Patent Application Publication
(10) Pub. No.: US 2026/0278736 A1
(43) Pub. Date: Sep. 17, 2026

(54) LARGE-VOLUME 3D IMAGE STITCHING METHOD, DEVICE, COMPUTER EQUIPMENT AND MEDIUM

(71) Applicant: ZHEJIANG HEHU TECHNOLOGY CO., LTD., HANGZHOU (CN)

(72) Inventor: YI YANG, HANGZHOU (CN)

(21) Appl. No.: 19/357,627

(22) Filed: Oct. 14, 2025

(30) Foreign Application Priority Data
Mar. 11, 2025 (CN) 202510279739.9

(51) Int. Cl. G06T 3/4038; G06T 7/12

(52) U.S. Cl. CPC G06T 3/4038; G06T 7/12; G06T 2207/20221

(57) ABSTRACT

A large-volume 3D image stitching method, device, computer equipment, and medium are provided. The method includes following steps: acquiring a to-be-stitched 3D image stack matrix V_{stack}, and extracting to-be-stitched boundaries of to-be-stitched sub-3D images; performing fusion calculation through a sigmoid function on adjacent to-be-stitched boundaries of all adjacent to-be-stitched sub-3D images to obtain smooth boundaries; performing boundary cropping, tensor reshaping and shape transformation on the to-be-stitched 3D image stack matrix V_{stack} according to the to-be-stitched boundaries to obtain a 3D matrix; and correspondingly applying all smooth boundaries to boundary junctions in the 3D matrix to obtain a seamlessly stitched 3D image.

### CROSS REFERENCE TO RELATED APPLICATIONS

The present disclosure claims the priority to the Chinese patent application with the filing No. 202510279739.9, entitled “LARGE-VOLUME 3D IMAGE STITCHING METHOD, DEVICE, COMPUTER EQUIPMENT AND MEDIUM” and filed on Mar. 11, 2025 with the Chinese Patent Office, the contents of which are incorporated herein by reference in their entirety.

### TECHNICAL FIELD

The present disclosure relates to the technical field of computer vision and image processing, and more particularly to a large-volume 3D image stitching technology.

### BACKGROUND ART

With the development of the computer vision and image processing technology, 3D image stitching plays an increasingly important role in the fields of medical imaging, geographic information system (GIS), virtual reality (VR), and augmented reality (AR), etc. In the above, the large-volume 3D image stitching has attracted considerable attention due to its application value in complex scenarios.

The large-volume 3D image stitching refers to the process of synthesizing multiple 3D data sets or images into a complete 3D model through computational processing. This process often involves complex algorithm design and high-performance computing power. Although the 3D image stitching technology has made a certain progress, many challenges still exist in achieving seamless stitching of large-volume images. First, due to the huge amount of data, how to efficiently store and process the data has become a key issue. Second, the stitching process requires precise matching of individual image blocks, especially at the edges and details, which requires a highly accurate registration algorithm to reduce errors.

Therefore, the problem that needs to be solved urgently by those skilled in the art is to achieve fast seamless stitching of large-volume 3D images.

### SUMMARY

In view of this, the present disclosure provides a large-volume 3D image stitching method, device, computer equipment and medium to achieve seamless stitching of 3D images with higher efficiency and better effect.

In order to achieve the above object, the present disclosure adopts the following technical solutions.

In a first aspect, the present disclosure provides a large-volume 3D (three-dimensional) image stitching method, including the following steps:
S1, acquiring a to-be-stitched 3D image stack matrix V_{stack}, and extracting to-be-stitched boundaries of to-be-stitched sub-3D images;
S2, performing fusion calculation through a sigmoid function on adjacent to-be-stitched boundaries of all adjacent to-be-stitched sub-3D images to obtain smooth boundaries;
S3, performing boundary cropping, tensor reshaping (dimension transformation) and shape transformation on the to-be-stitched 3D image stack matrix V_{stack} according to the to-be-stitched boundaries to obtain a 3D matrix; and
S4, correspondingly applying all smooth boundaries to boundary junctions in the 3D matrix to obtain a seamlessly stitched 3D image.

Further, step S1 specifically includes:
S11, acquiring the to-be-stitched 3D image stack matrix V_{stack}, where the to-be-stitched 3D image stack matrix V_{stack} includes all to-be-stitched sub-3D images; and
S12, extracting first boundaries Edge_{D1}, second boundaries Edge_{D2}, third boundaries Edge_{D3}, and fourth boundaries Edge_{D4} of the all to-be-stitched sub-3D images,
where the widths of the boundaries are all overlap pixels, and each to-be-stitched sub-3D image has the first boundary adjacent to the second boundary and the fourth boundary and opposite to the third boundary.

Further, the sigmoid function in step S2 is:

$$y = 1 / ( 1 + {e}^{- 10 \cdot ( x - 0.5 )} )$$

in the above, x represents the position index of each element in the to-be-calculated boundary, and y represents the fusion weight of each element in the to-be-fused boundary after calculation; and during the fusion calculation, the larger the row and column indexes of the boundary are, that is, the farther the boundary away from the sub image, and the smaller the fusion weight after calculation is.

Further, performing fusion calculation on adjacent two to-be-stitched boundaries of each to-be-stitched sub-3D image to obtain smooth boundaries in step 2 specifically includes:
stitching the first boundary of the to-be-stitched sub-3D image in the a-th row and the b-th column and the third boundary of the to-be-stitched sub-3D image in the a-th row and the b±1-th column to obtain a corresponding first smooth boundary,
where the calculation formula of the first smooth boundary is:

$${Edge}_{D 1} [ a , b , {d}_{k} , {h}_{i} , : ] = ( 1 - sigmoid ) \times {Edge}_{D 1} [ a , b , {d}_{k} , {h}_{i} , : ] + sigmoid \times {Edge}_{D 3} [ a , b \pm 1 , {d}_{k} , {h}_{i} , : ] ,$$

stitching the second boundary of the to-be-stitched sub-3D image in the a-th row and the b-th column and the fourth boundary of the to-be-stitched sub-3D image in the a±1-th row and the b-th column to obtain a corresponding second smooth boundary,
where the calculation formula of the second smooth boundary is:

$${Edge}_{D 2} [ a , b , {d}_{k} , : , {w}_{j} ] = ( 1 - sigmoid ) \times {Edge}_{D 2} [ a , b , {d}_{k} , : , {w}_{j} ] + sigmoid \times {Edge}_{D4} [ a \pm 1 , {d}_{k} , : , {w}_{j} ]$$

where 1≤a≤num_{y}, 1≤b≤numₓ, numₓ indicates the number of the to-be-stitched sub-3D images in the horizontal direction, and num_{y} indicates the number of the to-be-stitched sub-3D images in the vertical direction; dₖ represents the k-th layer images of the to-be-stitched sub-3D images, hᵢ represents the i-th row images of the to-be-stitched sub-3D images, and wⱼ represents the j-th column images of the to-be-stitched sub-3D images; 1≤k≤d, 1≤i≤h, 1≤j≤w, d indicates the pixel depth of the to-be-stitched sub-3D images, h indicates the pixel height of the to-be-stitched sub-3D images, and w indicates the pixel width of the to-be-stitched sub-3D images.

Further, step S3 specifically includes:
S31, cropping overlap/2 pixels from each of the boundaries of all the to-be-stitched sub-3D images to obtain the cropped 3D image stack;
S32, performing transpose transformation on the 3D image stack to change the dimension order and obtain a high-dimensional array; and
S33, constructing an empty array with the same shape as the high-dimensional array; use multithreading to parallelly fill each matrix into the empty array along the dimension d of the high-dimensional array; and performing a reshape operation on the filled empty array to change the number and size of dimensions, and transforming into a stitched 3D matrix with unsmoothed boundaries.

Further, step S4 specifically includes:
correspondingly applying the first smooth boundaries and the second smooth boundaries of the all to-be-stitched sub-3D images obtained in step S2 to the boundary junctions in the 3D matrix to obtain a seamlessly stitched 3D image.

In a second aspect, the present disclosure provides a large-volume 3D image stitching device, including the following modules:
an extraction module: used to acquire a to-be-stitched 3D image stack matrix V_{stack}, and extract to-be-stitched boundaries of to-be-stitched sub-3D images;
a fusion module: used to perform fusion calculation through a sigmoid function on adjacent to-be-stitched boundaries of all adjacent to-be-stitched sub-3D images to obtain smooth boundaries;
a transformation module: used to perform boundary cropping, tensor reshaping, and shape transformation on the to-be-stitched 3D image stack matrix V_{stack} according to the to-be-stitched boundaries to obtain a 3D matrix; and
a stitching module: used to corresponding apply all smooth boundaries to boundary junctions in the 3D matrix to obtain a seamlessly stitched 3D image.

In a third aspect, the present disclosure provides computer equipment including a processor, a communication interface, a memory, and a communication bus, where the processor, the communication interface, and the memory communicate with each other via the communication bus;
the memory is used for storing computer programs; and
the processor is used to implement the large-volume 3D image stitching method as described in any one of the first aspect when executing the programs stored on the memory.

In a fourth aspect, the present disclosure provides a computer-readable storage medium, where computer program instructions are stored on the computer-readable storage medium, and when the computer program instructions are executed by a processor, the processor is caused to execute the large-volume 3D image stitching method as described in any one of the first aspect.

The description of the second to fourth aspects of the present disclosure can refer to the detailed description of the first aspect; and the beneficial effects of the description of the second to fourth aspects can refer to the analysis of the beneficial effects of the first aspect, which will not be repeated here.

It can be known from the above technical solutions, compared with the prior art, the present disclosure provides a large-volume 3D image stitching method, which has the following beneficial effects.
1. The present disclosure only calculates the to-be-stitched boundaries, which greatly reduces the amount of data involved in the operation process and avoids the situation of low calculation efficiency and large memory usage caused by the computer repeatedly applying for a large amount of memory to store intermediate calculation results.
2. The present disclosure enables smooth and uniform transition between adjacent blocks by using sigmoid weighting on the to-be-stitched boundary regions.
3. By using the multithreading copy operation, the present disclosure greatly shortens the time required to apply for memory to store new arrays, when continuously performing transpose and reshape operations on the high-dimensional array.

### BRIEF DESCRIPTION OF DRAWINGS

In order to more clearly illustrate the technical solutions in embodiments of the present disclosure or in the prior art, the drawings required to be used in the description of the embodiments or the prior art will be briefly introduced below. Obviously, the drawings described below are merely embodiments of the present disclosure. For a person ordinarily skilled in the art, other drawings may be obtained based on the provided drawings without paying any creative work.

FIG. 1 is a flowchart of a large-volume 3D image stitching method provided by the present disclosure.

FIG. 2 is a schematic view of the large-volume 3D image stitching method provided by the present disclosure.

FIG. 3 is a block diagram of the large-volume 3D image stitching device provided by the present disclosure.

### DETAILED DESCRIPTION OF EMBODIMENTS

The technical solutions in the embodiments of the present disclosure will be clearly and completely described below in conjunction with the drawings in embodiments of the present disclosure. Obviously, the described embodiments are only some of the embodiments of the present disclosure, not all of the embodiments. Based on the embodiments of the present disclosure, all other embodiments obtained by a person ordinarily skilled in the art without paying creative efforts fall within the scope of protection of the present disclosure.

### Embodiment 1

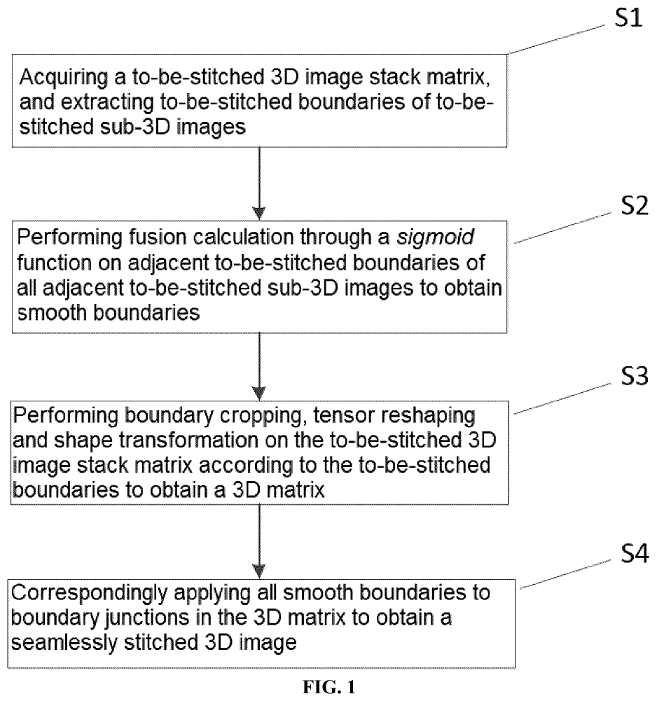

The embodiment of the present disclosure discloses a large-volume 3D image stitching method, as shown in FIG. 1, including the following steps:
S1, acquiring a to-be-stitched 3D image stack matrix V_{stack}, and extracting to-be-stitched boundaries of to-be-stitched sub-3D images;
S2, performing fusion calculation through a sigmoid function on adjacent to-be-stitched boundaries of all adjacent to-be-stitched sub-3D images, to obtain smooth boundaries;
S3, performing boundary cropping, tensor reshaping and shape transformation on the to-be-stitched 3D image stack matrix V_{stack} according to the to-be-stitched boundaries to obtain a 3D matrix; and
S4, correspondingly applying all smooth boundaries to boundary junctions in the 3D matrix to obtain a seamlessly stitched 3D image.

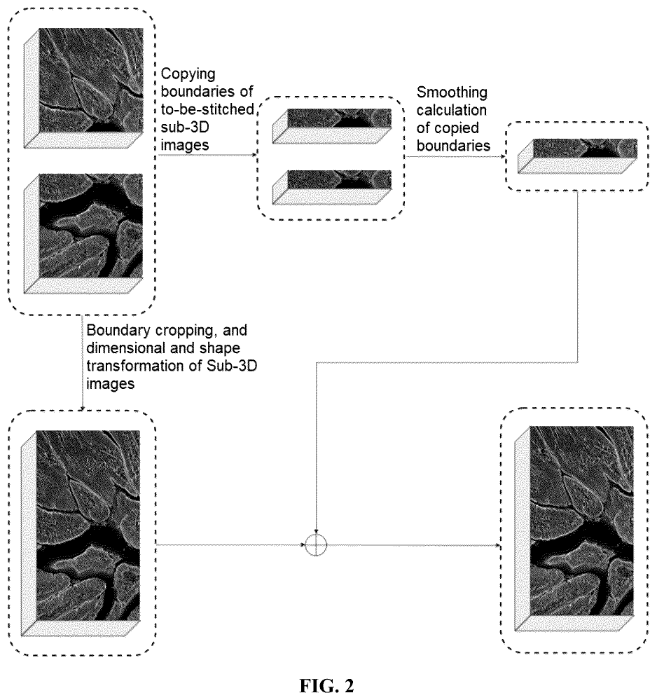

In the field of medical imaging, a series of two-dimensional sliced images of a brain are generated through CT scanning or MRI. These images are converted into 3D data through surface reconstruction, volume rendering, or segmentation technique, and appropriately cropped and resized. The image data from different imaging devices are fused to obtain more comprehensive patient information. In this example, 35 16-bit 3D images with a shape of 63*2000*2000 are acquired and subjected to a seamless stitching task. Referring to FIG. 2, the positions of the boundaries required to be stitched are first determined, and the pixel data of these boundaries is extracted; the sigmoid function is used to fuse the boundaries of two to-be-stitched image blocks, aiming to make the transition more natural, and only the boundaries are involved, and the operation is performed in place, avoiding repeatedly applying for memory and reducing resource and time consumption; and meanwhile, the stack matrix composed of all the to-be-stitched sub-3D images is subjected to boundary cropping and tensor reshaping, and multithreading copy operation and shape transformation are performed to change the number and size of dimensions. At this time, all the sub-3D images are stitched together, but not subjected to any smoothing yet. Finally, the previously calculated smooth boundaries are applied at the positions of the original stitching points to achieve a seamless stitching effect, resulting in a complete, high-resolution 3D model of the brain.

In this example, the to-be-stitched brain image stack matrix V_{stack} has a shape of num_{y}×numₓ×d×h×w, where num_{y} and numₓ indicates the numbers of sub-3D images of the brain in the vertical and horizontal directions respectively, d indicates the pixel depth of a single sub-3D image, h and w indicate the pixel height and width of the single sub-3D image respectively; and in this example, d=63, h=2000, w=2000, num_{y}×numₓ=35, and in this example, it is assumed that num_{y}=5 and numₓ=7.

The above steps are described below in detail.
Step S1: first, the overlap pixels of the upper, lower, left, and right boundaries (Edgeᵤₚ, Edge_{down}, Edge_{left}, Edge_{right}) of all sub-3D images of the brain are copied for subsequent use, where the right boundary is used as the first boundary, the upper boundary as the second boundary, the left boundary as the third boundary, and the lower boundary as the fourth boundary; where 1≤overlap<2000; their shapes are num_{y}×numₓ×d×overlap×w, num_{y}×numₓ×d×overlap×w, num_{y}×numₓ×d×h×overlap, and num_{y}×numₓ×d×h×overlap, respectively.

In this example, assuming overlap=100, and the shapes thereof are 5×7×63×100×2000, 5×7×63×100×2000, 5×7×63×2000×100, and 5×7×63×2000×100 respectively, the smaller the overlap value is, the fewer the pixels are required for boundary fusion and smoothing calculation, the less the amount of calculation is, and the shorter the calculation time is.

In step S2, in order to erase the seams between adjacent sub-3D images of the brain, it is necessary to perform smoothing calculation on the corresponding boundaries, and the smoothing operation may be achieved by performing sigmoid fusion on the adjacent boundaries, where the sigmoid function is:

$$y = 1 / ( 1 + {e}^{- 10 \cdot ( x - 0.5 )} )$$

in the above, x represents the position index of each element in the to-be-calculated boundary, and y represents the fusion weight of each element in the to-be-fused boundary after calculation; and during the fusion calculation, the larger the row and column indexes of the boundary are, that is, the farther the boundary is away from the sub image, and the smaller the calculated fusion weight is, and vice versa.

Description is made by taking two sub-3D images of the brain in the first row, and in the first column and the second column in V_{stack} as an example. Since the sigmoid function is monotonically decreasing, the actual calculation process may be expressed as follows:

$${Edge}_{right} [ 1 , 1 , {d}_{k} , {h}_{i} , : ] = ( 1 - sigmoid ) \times {Edge}_{right} [ 1 , 1 , {d}_{k} , {h}_{i} , : ] + sigmoid \times {Edge}_{left} [ 1 , 2 , {d}_{k} , {h}_{i} , : ]$$

in the above, dₖ represents the k-th layer images, hᵢ represents the i-th row of the images, and k is traversed sequentially from 1 to 63 and i is traversed from 1 to 2000 to complete one smoothing calculation between adjacent blocks, and then the above calculation process is extended to all adjacent blocks in V_{stack}.

In this example, the smooth boundaries of the upper boundaries and the smooth boundaries of the right boundaries of all to-be-stitched sub-3D images are calculated.

The calculation formula for the smooth boundary of the right boundary is:

$${Edge}_{right} [ a , b , {d}_{k} , {h}_{i} , : ] = ( 1 - sigmoid ) \times {Edge}_{right} [ a , b , {d}_{k} , {h}_{i} , : ] + sigmoid \times {Edge}_{left} [ a , b + 1 , {d}_{k} , {h}_{i} , : ]$$

The calculation formula for the smooth boundary of the upper boundary is:

$${Edge}_{up} [ a , b , {d}_{k} , : , {w}_{j} ] = ( 1 - sigmoid ) \times {Edge}_{up} [ a , b , {d}_{k} , : , {w}_{j} ] + sigmoid \times {Edge}_{down} [ a - 1 , b , {d}_{k} , : , {w}_{j} ]$$

In this example, 1≤a≤7, 1≤b≤5; dₖ represents the k-th layer images of the to-be-stitched sub-3D images, hᵢ represents the i-th row of the to-be-stitched sub-3D images; 1≤k≤63, and 1≤i≤2000.

By copying the boundaries and performing calculation on only the to-be-stitched regions of the brain, this example greatly reduces the amount of data involved in the calculation process and avoids the situation of low calculation efficiency and large memory usage caused by the computer repeatedly applying for a large amount of memory to store intermediate calculation results. This example enables smooth and uniform transition between adjacent blocks by using sigmoid weighting on the overlapping regions.

Step S3 specifically includes:
S31, boundary cropping of sub-3D images: in order to make the total number of pixels of original V_{stack} same as the number of pixels after stitching, overlap/2 pixels needs to be cropped from the upper, lower, left and right boundaries of each sub-3D image of V_{stack}, i.e., 50 pixels are cropped, to obtain a 3D image stack V_{stack_cut} with a shape of num_{y}×numₓ×d×(h-overlap/2×2)×(w-overlap/2×2), i.e., a shape of 5×7×63×(2000−100)×(2000−100);
S32, tensor reshaping of the 3D image stack: the 3D image stack V_{stack_cut} with the shape of num_{y}×numₓ×d×(h-overlap/2×2)×(w-overlap/2×2) are subjected to transpose, to chang the dimension order to transform into a high-dimensional array V_{stack_trans} with a shape of d×num_{y}×(h-overlap/2×2)×numₓ×(w-overlap/2×2), i.e. a shape of 63×5×(2000−100)×7×(2000−10); and
S33, multi-threading replication and shape transformation: after obtaining the V_{stack_trans}, an empty array V_{stack_trans_copy} with a shape of d×num_{y}×(h-overlap/2×2)×numₓ×(w-overlap/2×2) is created, each matrix with the shape of 1×num_{y}×(h-overlap/2×2)×numₓ×(w-overlap/2×2) of V_{stack_trans} is parallelly filled into V_{stack_trans_copy} by using multithreading along the dimension d of V_{stack_trans}, and after the filling is completed, the V_{stack_trans_copy} is subjected to a reshape operation to change the number and size of dimensions without changing the product, to transform into a 3D matrix V_{stack_trans_copy_reshape} with the shape of d×(num_{y}×(h-overlap/2×2))×(numₓ×(w-overlap/2×2)), where the 3D matrix is the stitched 3D image of 63×{5×(2000−100)}×{7×(2000−100)}, in which the boundaries between the sub images are not smoothed.

Finally, step S4 is performed, to correspondingly apply the smooth boundaries of the upper boundaries and the smooth boundaries of the right boundaries of all to-be-stitched sub-3D images obtained in step S2 to the pixels at the boundary junction positions in the 3D matrix V_{stack_trans_copy_reshape} obtained in step S3, to obtain a seamlessly stitched 3D image.

In this example, the smoothing calculation operation involves only boundaries and is performed in place, avoiding repeatedly applying for memory, and reducing resource and time consumption; and the transpose and reshape are decoupled and connection is performed through multithreading copy operation, greatly reducing the time for array dimension transformation and shape transformation.

### Embodiment 2

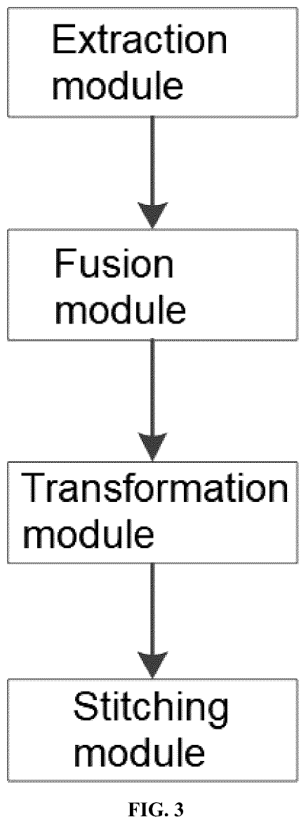

The embodiment of the present disclosure discloses a large-volume 3D image stitching device, as shown in FIG. 3, including the following modules:
an extraction module: used to acquire a to-be-stitched 3D image stack matrix V_{stack}, and extract to-be-stitched boundaries of to-be-stitched sub-3D images;
a fusion module: used to perform fusion calculation through a sigmoid function on adjacent to-be-stitched boundaries of all adjacent to-be-stitched sub-3D images to obtain smooth boundaries;
a transformation module: used to perform boundary cropping, tensor reshaping, and shape transformation on the to-be-stitched 3D image stack matrix V_{stack} according to the to-be-stitched boundaries to obtain a 3D matrix; and
a stitching module: used to correspondingly apply all smooth boundaries to boundary junctions in the 3D matrix to obtain a seamlessly stitched 3D image.

In this embodiment, that the device achieves rapidly and seamlessly stitching of large-volume 3D images is crucial for improving image quality and applicability of application scenarios. Seamless stitching ensures that the resulting synthesized 3D model possesses greater accuracy and completeness, which is particularly important in fields such as medical diagnosis and scientific research. For example, medically, high-quality 3D models help doctors more clearly know the location and morphology of lesions and thus make more precise treatment plans. Rapidly achieving this seamless stitching significantly shortens data processing time and improves working efficiency, making it particularly valuable for time-sensitive applications such as clinical diagnosis.

### Embodiment 3

The present disclosure further provides computer equipment including a processor, a communication interface, a memory and a communication bus, where the processor, the communication interface and the memory communicate with each other via the communication bus; and
the large-volume 3D image stitching method in Embodiment 1 is implemented when the processor executes the programs. For the sake of brevity, it will not be described in detail here.

It should be understood that in this embodiment, the processor may be a central processing unit (CPU). The processor may also be other general-purpose processor, digital signal processor (DSP), application-specific integrated circuit (ASIC), off-the-shelf field-programmable gate array (FPGA) or other programmable logic device, discrete gate or transistor logic device, discrete hardware component, etc. The general-purpose processor may be a microprocessor or the processor may be any conventional processor, etc.

The memory may include a read-only memory and a random-access memory, and provides instructions and data to the processor. A portion of the memory may also include a non-volatile random-access memory. For example, the memory may also store information about the device type.

During implementation, each step of the above method may be completed by an integrated logic circuit of hardware in a processor or by instructions in the form of software.

### Embodiment 4

The present disclosure further provides a computer-readable storage medium, where computer program instructions are stored on the computer-readable storage medium. When the computer program instructions are executed by a processor, the processor is caused to execute the large-volume 3D image stitching method as described in any one of the examples in Embodiment 1.

In this specification, the embodiments are described in a progressive manner, and each embodiment focuses on the differences from other embodiments. The same or similar parts between the embodiments may be referred to each other. For the device disclosed in the embodiment, since it corresponds to the method disclosed in the embodiment, the description is relatively simple, and the relevant parts may be referred to the method parts.

The above description of the disclosed embodiments enables one skilled in the art to implement or use the present application. Various modifications to these embodiments will be obvious to one skilled in the art, and the general principles defined herein may be implemented in other embodiments without departing from the spirit or scope of the present disclosure. Therefore, the present disclosure will not be limited to the embodiments shown herein, but rather will conform to the widest scope consistent with the principles and novel features disclosed herein.

1. A large-volume 3D image stitching method, comprising following steps:
S1, acquiring a to-be-stitched 3D image stack matrix V_{stack}, and extracting to-be-stitched boundaries of to-be-stitched sub-3D images;
S2, performing fusion calculation through a sigmoid function on adjacent to-be-stitched boundaries of all adjacent to-be-stitched sub-3D images, to obtain smooth boundaries;
S3, performing boundary cropping, tensor reshaping, and shape transformation on the to-be-stitched 3D image stack matrix V_{stack} according to the to-be-stitched boundaries to obtain a 3D matrix; and
S4, correspondingly applying all smooth boundaries to boundary junctions in the 3D matrix to obtain a seamlessly stitched 3D image.

2. The large-volume 3D image stitching method according to claim 1, wherein step S1 specifically comprises:
S11, acquiring the to-be-stitched 3D image stack matrix V_{stack}, wherein the to-be-stitched 3D image stack matrix V_{stack} comprises all of the to-be-stitched sub-3D images; and
S12, extracting first boundaries Edge_{D1}, second boundaries Edge_{D2}, third boundaries Edge_{D3}, and fourth boundaries Edge_{D4} of all of the to-be-stitched sub-3D images;
wherein widths of the boundaries are each overlap pixels, and each of the to-be-stitched sub-3D images has the first boundary adjacent to the second boundary and the fourth boundary and opposite to the third boundary.

3. The large-volume 3D image stitching method according to claim 2, wherein the sigmoid function in step S2 is:
$$y = 1 / ( 1 + {e}^{- 10 \cdot ( x - 0.5 )} ) ,$$
wherein x represents a position index of each element in a to-be-calculated boundary, and y represents a fusion weight of each element in a to-be-fused boundary after calculation; and during the fusion calculation, the larger the row and column indexes of the boundary are, that is, the farther the boundary is away from a sub image, and the smaller the fusion weight after the calculation is.

4. The large-volume 3D image stitching method according to claim 3, wherein in step 2, adjacent two to-be-stitched boundaries of each adjacent to-be-stitched sub-3D images are subjected to fusion calculation to obtain smooth boundaries, which specifically comprises:
stitching a first boundary of a to-be-stitched sub-3D image in an a-th row and a b-th column and a third boundary of a to-be-stitched sub-3D image in the a-th row and a b±1-th column to obtain a corresponding first smooth boundary,
wherein a calculation formula of the first smooth boundary is:
$${Edge}_{D 1} [ a , b , {d}_{k} , {h}_{i} , : ] = ( 1 - sigmoid ) \times {Edge}_{D 1} [ a , b , {d}_{k} , {h}_{i} , : ] + sigmoid \times {Edge}_{D 3} [ a , b \pm 1 , {d}_{k} , {h}_{i} , : ] ;$$
stitching a second boundary of the to-be-stitched sub-3D image in the a-th row and the b-th column and a fourth boundary of a to-be-stitched sub-3D image in an a±1-th row and the b-th column to obtain a corresponding second smooth boundary,
wherein a calculation formula of the second smooth boundary is:
$${Edge}_{D 2} [ a , b , {d}_{k} , : , {w}_{j} ] = ( 1 - sigmoid ) \times {Edge}_{D 2} [ a , b , {d}_{k} , : , {w}_{j} ] + sigmoid \times {Edge}_{D4} [ a \pm 1 , {d}_{k} , : , {w}_{j} ] ,$$
wherein 1≤a≤num_{y}, 1≤b≤numₓ, numₓ indicates number of the to-be-stitched sub-3D images in a horizontal direction, and num_{y} indicates number of the to-be-stitched sub-3D images in a vertical direction; dₖ represents k-th layer images of the to-be-stitched sub-3D images, hᵢ represents i-th row images of the to-be-stitched sub-3D images, and wⱼ represents j-th column images of the to-be-stitched sub-3D images; 1≤k≤d, 1≤i≤h, 1≤j≤w, d indicates a pixel depth of the to-be-stitched sub-3D images, h indicates a pixel height of the to-be-stitched sub-3D images, and w indicates a pixel width of the to-be-stitched sub-3D images.

5. The large-volume 3D image stitching method according to claim 4, wherein step S3 specifically comprises:
S31, cropping overlap/2 pixels from each of the boundaries of all the to-be-stitched sub-3D images to obtain a cropped 3D image stack;
S32, performing transpose transformation on the 3D image stack to change a dimension order and obtain a high-dimensional array; and
S33, constructing an empty array with a same shape as the high-dimensional array, use multithreading to parallelly fill each matrix into the empty array along a dimension d of the high-dimensional array, and performing a reshape operation on the filled empty array to change number and size of dimensions, and transforming into a stitched 3D matrix with unsmoothed boundaries.

6. The large-volume 3D image stitching method according to claim 5, wherein step S4 specifically comprises:
correspondingly applying the first smooth boundaries and the second smooth boundaries of the all to-be-stitched sub-3D images obtained in step S2 to the boundary junctions in the 3D matrix to obtain a seamlessly stitched 3D image.

7. A large-volume 3D image stitching device, comprising following modules:
an extraction module: configured to acquire a to-be-stitched 3D image stack matrix V_{stack}, and extract to-be-stitched boundaries of to-be-stitched sub-3D images;
a fusion module: configured to perform fusion calculation through a sigmoid function on adjacent to-be-stitched boundaries of all adjacent to-be-stitched sub-3D images to obtain smooth boundaries;
a transformation module: configured to perform boundary cropping, tensor reshaping, and shape transformation on the to-be-stitched 3D image stack matrix V_{stack} according to the to-be-stitched boundaries to obtain a 3D matrix; and
a stitching module: configured to correspondingly apply all smooth boundaries to boundary junctions in the 3D matrix to obtain a seamlessly stitched 3D image.

8. Computer equipment, comprising a processor, a communication interface, a memory, and a communication bus, wherein the processor, the communication interface, and the memory communicate with each other via the communication bus;
the memory is configured for storing computer programs; and
the processor is configured to implement the large-volume 3D image stitching method according to claim 1 when executing the programs stored on the memory.

9. A computer-readable storage medium, wherein computer program instructions are stored on the computer-readable storage medium, and when the computer program instructions are executed by a processor, the processor is caused to execute the large-volume 3D image stitching method according to claim 1.
